(19) United States
(12) Patent Application Publication
(10) Pub. No.: US 2016/0371792 A1
(43) Pub. Date: Dec. 22, 2016

(54) Method and Apparatus for Mining Social Relationship Based on Financial Data

(71) Applicant: Huawei Technologies Co., Ltd., Shenzhen (CN)

(72) Inventors: Jun Luo, Shenzhen (CN); Liangwei Wang, Shenzhen (CN); Nan Hu, Shenzhen (CN)

(21) Appl. No.: 15/251,000

(22) Filed: Aug. 30, 2016

Related U.S. Application Data
(63) Continuation of application No. PCT/CN2014/089034, filed on Oct. 21, 2014.

(30) Foreign Application Priority Data
Mar. 10, 2014 (CN) 201410085416.8

(51) Int. Cl. G06Q 50/00; G06Q 30/02

(52) U.S. Cl. CPC G06Q 50/01; G06Q 30/0201

(57) ABSTRACT

A method and an apparatus for mining a social relationship based on financial data is presented. The method for mining a social relationship based on financial data in the present disclosure includes: acquiring financial transaction data of a client user; determining a financial transaction network according to the financial transaction data; determining a network topology attribute of the client user and a non-network topology attribute of the client user according to the financial transaction network; and determining, according to a topology attribute of the financial transaction network and the non-network topology attribute, a social relationship corresponding to the client user.

### CROSS-REFERENCE TO RELATED APPLICATIONS

This application is a continuation of International Application No. PCT/CN2014/089034, filed on Oct. 21, 2014, which claims priority to Chinese Patent Application No. 201410085416.8, filed on Mar. 10, 2014, both of which are hereby incorporated by reference in their entireties.

### TECHNICAL FIELD

Embodiments of the present disclosure relate to the field of computer science technologies, and in particular, to a method and an apparatus for mining a social relationship based on financial data.

### BACKGROUND

Currently, competition in the banking industry is very fierce. Continuously increasing a quantity of customers is the only road for the survival of a bank. The booming development of Internet finance has great impact on conventional banks. For example, Yu'e Bao, a financial product platform developed by Alibaba, has raised 5.7 billion renminbi (RMB) in only 18 days, and over 50 billion RMB in three months since its launch. How to detain existing customers, attract new customers, and distinguish high quality customers becomes a key to improving bank profits.

The conventional discovery of a social relationship between bank customers mainly relies on content written in an application form by a customer when the customer applies for a bank card, for example, finding out a colleague relationship through a collecting person, and finding out a family relationship through a main credit card and an attached credit card, or a loan guarantee.

However, efficiency of determining a social relationship between bank customers using this method is too low.

### SUMMARY

Embodiments of the present disclosure provide a method and an apparatus for mining a social relationship based on financial data, to overcome a problem in the prior art that efficiency of identifying, based on a simple rule, a social relationship between bank customers is low.

A first aspect of the present disclosure provides a method for mining a social relationship based on financial data, including acquiring financial transaction data of a client user; determining a financial transaction network according to the financial transaction data; determining a network topology attribute of the client user and a non-network topology attribute of the client user according to the financial transaction network; and determining, according to a topology attribute of the financial transaction network and the non-network topology attribute, a social relationship corresponding to the client user.

With reference to the first aspect, in a first possible implementation manner of the first aspect, the financial transaction data of the client user includes an attribute of the client user, a transaction behavior of the client user, a fund flow of the client user, a fund amount of the client user, and a transaction time, a transaction type, and a transaction memo of the client user; and the determining a financial transaction network according to the financial transaction data includes determining nodes of the financial transaction network according to the client user, determining a node attribute of the financial transaction network according to the attribute of the client user, determining edges of the financial transaction network according to the transaction behavior of the client user, where the nodes are connected using the edges, determining directions of the edges according to the fund flow of the client user, determining weights of the edges of the financial transaction network according to the fund amount of the client user, and determining attributes of the edges of the financial transaction network according to the transaction time, the transaction type, and the transaction memo of the client user.

With reference to the first aspect or the first possible implementation manner of the first aspect, in a second possible implementation manner of the first aspect, the financial transaction data includes first data and second data, where the first data refers to a client user whose social relationship is annotated and the second data refers to a client user whose social relationship is not annotated; and the determining, according to a topology attribute of the financial transaction network and the non-network topology attribute, a social relationship corresponding to the client user includes determining a classification model according to a network topology attribute and a non-network topology attribute of the first data; and acquiring, according to the classification model, a social relationship of a client user corresponding to the second data.

With reference to the second possible implementation manner of the first aspect, in a third possible implementation manner of the first aspect, the determining a classification model according to a network topology attribute and a non-network topology attribute that correspond the first data includes selecting an attribute according to the network topology attribute of the financial transaction network and the non-network topology attribute; determining a training data set and a test data set according to the first data; constructing the classification model according to the training data set and the attribute using a data mining classification algorithm; and testing, according to the test data set, whether the classification model passes a model assessment.

With reference to the third possible implementation manner of the first aspect, in a fourth possible implementation manner of the first aspect, acquiring a social relationship of data in the test data set using the classification model, and calculating a match rate between the acquired social relationship of the data in the test data set and an annotated social relationship of the data in the test data set; and if the match rate is higher than a first threshold, determining that the classification model passes the model assessment; or if the match rate is not higher than the first threshold, continuing training the classification model.

With reference to the first aspect or any one of the first to the fourth possible implementation manners of the first aspect, in a fifth possible implementation manner of the first aspect, the determining, according to a topology attribute of the financial transaction network and the non-network topology attribute, a social relationship corresponding to the client includes performing network clustering according to the topology attribute of the financial transaction network and the non-network topology attribute, to acquire the social relationship of the client user.

A second aspect of the present disclosure provides an apparatus for mining a social relationship based on financial data, including an acquiring module configured to acquire financial transaction data of a client user; a first determining module configured to determine a financial transaction network according to the financial transaction data acquired by the acquiring module; a second determining module configured to determine a network topology attribute of the client user and a non-network topology attribute of the client user according to the financial transaction network determined by the first determining module; and a third determining module configured to determine, according to a topology attribute of the financial transaction network and the non-network topology attribute that is determined by the second determining module, a social relationship corresponding to the client user.

In a first possible implementation manner of the second aspect, the first determining module is configured to the financial transaction data of the client user includes an attribute of the client user, a transaction behavior of the client user, a fund flow of the client user, a fund amount of the client user, and a transaction time, a transaction type, and a transaction memo of the client user; and determine nodes of the financial transaction network according to the client user, determine a node attribute of the financial transaction network according to the attribute of the client user, determine edges of the financial transaction network according to the transaction behavior of the client user, where the nodes are connected using the edges, determine directions of the edges according to the fund flow of the client user, determine weights of the edges of the financial transaction network according to the fund amount of the client user, and determine attributes of the edges of the financial transaction network according to the transaction time, the transaction type, and the transaction memo of the client user.

With reference to the second aspect or the first possible implementation manner of the second aspect, in a second possible implementation manner of the second aspect, the financial transaction data includes first data and second data, where the first data refers to a client user whose social relationship is annotated and the second data refers to a client user whose social relationship is not annotated; and the third determining module includes a model determining unit and a relationship determining unit, where the model determining unit is configured to determine a classification model according to a network topology attribute and a non-network topology attribute of the first data; and the relationship determining unit is configured to acquire, according to the classification model determined by the model determining unit, a social relationship of a client user corresponding to the second data.

With reference to the second possible implementation manner of the second aspect, in a third possible implementation manner of the second aspect, the model determining unit is configured to select an attribute according to the network topology attribute of the financial transaction network and the non-network topology attribute; determine a training data set and a test data set according to the first data; construct the classification model according to the training data set and the attribute using a data mining classification algorithm; and test, according to the test data set, whether the classification model passes a model assessment.

With reference to the third possible implementation manner of the second aspect, in a fourth possible implementation manner of the second aspect, the model determining unit is configured to acquire a social relationship of data in the test data set using the classification model, and calculate a match rate between the acquired social relationship of the data in the test data set and an annotated social relationship of the data in the test data set; and if the match rate is higher than a first threshold, determine that the classification model passes the model assessment; or if the match rate is not higher than the first threshold, continue training the classification model.

With reference to the second aspect or any one of the first to the fourth possible implementation manners of the second aspect, in a fifth possible implementation manner of the second aspect, the third determining module is configured to perform network clustering according to the topology attribute of the financial transaction network and the non-network topology attribute, to acquire the social relationship of the client user.

According to the method and the apparatus for mining a social relationship based on financial data in the embodiments of the present disclosure, a financial transaction network is constructed using financial transaction data, a network topology attribute of a client user and a non-network topology attribute of the client user are determined according to the financial transaction network, a classification model is constructed according to the network topology attribute and the non-network topology attribute, colleague and non-colleague relationships and family and non-family relationships that correspond to the client are determined using the classification model, cluster analysis is performed on a calculation result of the network topology attribute and the non-network topology attribute, and a friend relationship corresponding to the client user is determined, thereby resolving problems in the prior art that efficiency of determining a social relationship between the client users is low and the social relationships of the client user are not totally discovered.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show some embodiments of the present disclosure, and persons of ordinary skill in the art may still derive other drawings from these accompanying drawings without creative efforts.

FIG. 1 is a flowchart of Embodiment 1 of a method for mining a social relationship based on financial data according to the present disclosure;

FIG. 2 is an overall architectural diagram of the present disclosure;

FIG. 3 is a flowchart for calculating a network topology attribute according to the present disclosure;

FIG. 4 is a flowchart for constructing and testing a classification model according to the present disclosure;

FIG. 5 is a schematic structural diagram of Embodiment 1 of an apparatus for mining a social relationship based on financial data according to the present disclosure; and

FIG. 6 is a schematic structural diagram of Embodiment 2 of an apparatus for mining a social relationship based on financial data according to the present disclosure.

### DESCRIPTION OF EMBODIMENTS

To make the objectives, technical solutions, and advantageous effect of the embodiments of the present disclosure clearer, the following clearly describes the technical solutions in the embodiments of the present disclosure with reference to the accompanying drawings in the embodiments of the present disclosure. The described embodiments are a part rather than all of the embodiments of the present disclosure. All other embodiments obtained by persons of ordinary skill in the art based on the embodiments of the present disclosure without creative efforts shall fall within the protection scope of the present disclosure.

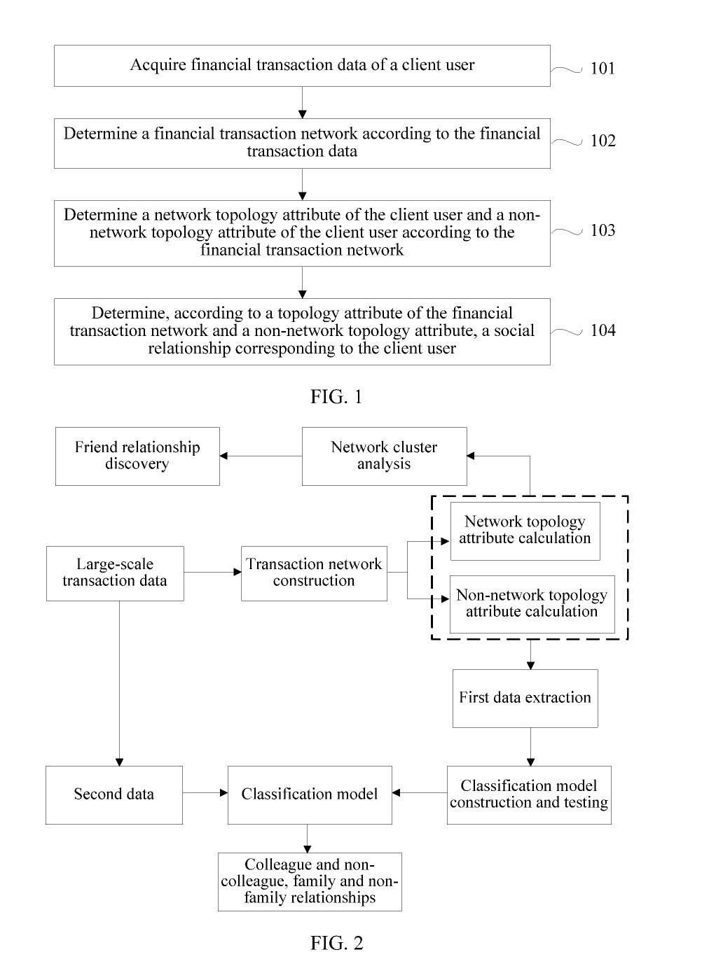

FIG. 1 is a flowchart of Embodiment 1 of a method for mining a social relationship based on financial data according to the present disclosure. As shown in FIG. 1, the method of this embodiment may include the following steps.

Step 101: Acquire financial transaction data of a client user.

The financial transaction data of the client user is acquired from a transaction record of the client user. The transaction record may be a transfer transaction of the client user, or may be a consumption transaction of the client user. The financial transaction data acquired from the transaction record not only includes a time of this transaction, but also includes transaction attributes such as a transaction location and a transaction amount. In addition, the transaction record further records personal information of the client user corresponding to this transaction. The financial transaction data includes financial transaction data whose social relationship, such as a colleague or family relationship, of the client user is annotated and financial transaction data whose social relationship is not annotated.

Step 102: Determine a financial transaction network according to the financial transaction data.

An overall process in which a server constructs the financial transaction network according to the financial transaction data mainly includes the following several steps: first, storage of a big data database, where a large amount of transaction records are stored into a database Hive; second, address mapping of a client user, where an address may be a network identifier (ID) or an external ID of the client user, and secondary mapping is performed on the client user ID according to database data, such as Hive data, thereby ensuring uniqueness of the corresponding client user ID in a process of constructing a network, and also decreasing space occupied by a network file; third, characteristic selection, where characteristic selection is performed according to the financial transaction data, to determine a time interval of constructing a network and attribute information that needs to be reflected on the network; fourth, weight calculation, where weight calculation of edges in the financial transaction network is determined according to a calculation result of the characteristic selection, for example, if a quantity of transaction times is selected as the weight, transaction records of client users having a same quantity of transaction times are analyzed using the database Hive; fifth, completing sorting external IDs by means of the Hive data, using sorted data as a data input for network construction, and implementing construction of a general network construction file .net using a network construction program. Sorted data is used as an input file for network construction, to perform network construction, so that time complexity of the construction process can be decreased. For a problem that a construction time of a network having a large amount of data is long, in this embodiment, sorting and mapping for network construction are completed based on the big data database, thereby improving the overall construction efficiency.

Step 103: Determine a network topology attribute of the client user and a non-network topology attribute of the client user according to the financial transaction network.

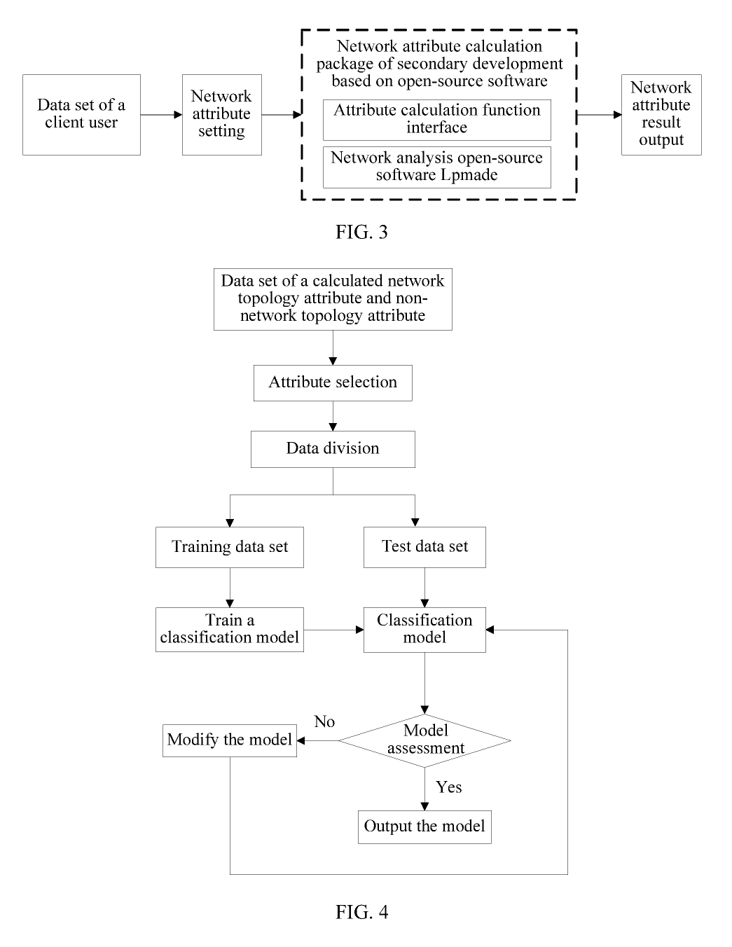

Network data in the financial transaction network can well reflect a relationship and a close degree between the client users, and network topology attributes of different relationships on the financial transaction network are obviously different. For example, a common neighboring node exists between nodes of a colleague relationship, directions and weights between nodes of a family relationship are obviously different from a general transaction record, and the like, which can all be reflected by a network attribute. The network topology attribute calculated in this embodiment mainly includes: Adamic Adar, a common neighbor, a clustering coefficient, a distance, a degree, a page rank, a volume, a Jaccard coefficient, and the like between two nodes. A process of calculating the network topology attribute is shown in FIG. 3.

The non-network topology attribute between the client users corresponding to the financial transaction network is mainly from the perspective of a transaction attribute, and non-network attribute design and calculation are performed according to a characteristic of the financial transaction data, mainly including a time dimension, a space dimension, a transaction amount, a transaction flow, and the like. The time dimension is mainly divided into two parts: a week rule and a day rule. The week rule refers to that a quantity of transaction times in a week, that is, seven days, correspondingly form seven non-network attribute characteristics; and the day rule refers to that calculation is performed according to a quantity of transaction times every day, that is, 24 hours, to form 24 non-network attribute characteristics. The space dimension is to collect statistics on an overlapping degree of activity locations of two client users that make a transaction. The transaction amount refers to an amount involved in the transaction between two client users, and may include a yearly total transaction amount, a month average transaction amount, or measurement such as a difference between income and expenditure. The transaction flow is to collect statistics on a fund flow in a transaction record between two client users. For example, if a client user A transfers money to a client user B five times, and the client user B transfers money to the client user A once, a transaction flow attribute value between the client user A and the client user B is four times.

The non-network topology attribute in this embodiment has great clustering function for client users having a similar background, and has a great distinguishing function for client users having different backgrounds. For example, for a transaction location, most client users in a same area choose to make a transaction at a same online store, and for a transaction time, client users making a transaction at working hours are mainly office workers.

Step 104: Determine, according to a topology attribute of the financial transaction network and the non-network topology attribute, a social relationship corresponding to the client user.

In this embodiment, there are two methods for determining, according to the topology attribute of the financial transaction network and the non-network topology attribute, the social relationship corresponding to the client user.

The financial transaction data includes first data and second data, where the first data refers to data whose social relationship is annotated and the second data refers to data whose social relationship is not annotated.

Optionally, the determining, according to a topology attribute of the financial transaction network and the non-network topology attribute, a social relationship corresponding to the client user includes determining a classification model according to a network topology attribute and a non-network topology attribute of the first data; and acquiring, according to the classification model, a social relationship of a client user corresponding to the second data.

Optionally, the determining, according to a topology attribute of the financial transaction network and the non-network topology attribute, a social relationship corresponding to the client includes performing network clustering according to the topology attribute of the financial transaction network and the non-network topology attribute, to acquire the social relationship of the client user.

Further, the determining a classification model according to a network topology attribute and a non-network topology attribute that correspond to the first data includes selecting an attribute according to the network topology attribute of the financial transaction network and the non-network topology attribute; determining a training data set and a test data set according to the first data; constructing the classification model according to the training data set and the attribute using a data mining classification algorithm, where a common data mining classification algorithm includes a decision tree algorithm, a random forest algorithm, and the like; and testing, according to the test data set, whether the classification model passes a model assessment.

Further, the testing, according to the test data set, whether the classification model passes a model assessment includes acquiring a social relationship of data in the test data set using the classification model, and calculating a match rate between the acquired social relationship of the data in the test data set and an annotated social relationship of the data in the test data set; and if the match rate is higher than a first threshold, determining that the classification model passes the model assessment; or if the match rate is not higher than the first threshold, continuing training the classification model.

The server determines colleague and non-colleague relationships and family and non-family relationships that correspond to the client according to a calculation result of the topology attribute of the financial transaction network and the non-network topology attribute using the classification model; and acquires a friend relationship of the client user by means of network clustering. The classification model is determined according to a data set that is obtained after calculation of the network topology attribute of the financial transaction network and the non-network topology attribute. A process of constructing the classification model of this embodiment is shown in FIG. 4. First, attribute selection is performed on the data set obtained after calculation of the network topology attribute of the financial transaction network and the non-network topology attribute, for example, selecting a transaction location in a transaction attribute and then dividing a transaction data set corresponding to the transaction location into two parts: the training data set and the test data set, where the training data set is used to train the classification model, and the test data set is used to test whether the classification model passes the model assessment. The first threshold is set, and a social relationship of data in the test data set is acquired using the classification model. A match rate between the acquired social relationship of the data in the test data set and an annotated social relationship of the data in the test data set is calculated. If the match rate is higher than the first threshold, it is determined that the classification model passes the model assessment, and the classification model is output; and if the match rate is not higher than the first threshold, the classification model is modified and output. The model assessment determines whether all annotated social relationships of client users in the test data set are the same as social relationships of client user calculated using the classification model in the training data set. In this embodiment, a random forest classification method and a decision tree classification method are used to construct the classification model.

The network clustering method is a community discovery method. A community phenomenon is a common phenomenon in a complex network and displays a community characteristic owned by multiple individuals. The community discovery method is a method used to mine the community characteristic occupied by the multiple individuals. First, a constructed financial transaction network is used as an input of a discovery community calculation model. Then, a server performs processing and preliminary clustering of communities using large-scale network analysis software. Lastly, secondary analysis is performed on a preliminary clustering result, to acquire a community structure of a client user, where the community structure is a friend circle of the client user, and a friend relationship between client users is annotated according to the friend circle.

Further, determining, by the server, a financial transaction network according to the financial transaction data includes determining nodes of the financial transaction network according to the client user, determining a node attribute of the financial transaction network according to the attribute of the client user, determining edges of the financial transaction network according to the transaction behavior of the client user, where the nodes are connected using the edges, determining directions of the edges according to the fund flow of the client user, determining weights of the edges of the financial transaction network according to the fund amount of the client user, and determining attributes of the edges of the financial transaction network according to the transaction time, the transaction type, and the transaction memo of the client user.

In this embodiment, the financial transaction data is used for experiment, to construct a colleague and non-colleague classification model and a family relationship model of a client user. An experiment result is shown in Table 1.

TABLE 1

| | | Size of | Model | Model | |
|---|---|---|---|---|---|
| Model name | Model method | data set | accuracy | recall rate | F-metric |
| Colleague and | Decision tree | 16 W | 0.861 | 0.861 | 0.861 |
| non-colleague | | | | | |
| relationships prediction | | | | | |
| Colleague and | Random forest | 16 W | 0.883 | 0.883 | 0.883 |
| non-colleague | | | | | |
| relationships prediction | | | | | |
| Family relationship | Decision tree | 2 W | 0.806 | 0.806 | 0.806 |
| prediction | | | | | |
| Family relationship | Random forest | 2 W | 0.839 | 0.835 | 0.835 |
| prediction | | | | | |

As shown in FIG. 2, in this embodiment, a financial transaction network is constructed using financial transaction data, a network topology attribute of a client user and a non-network topology attribute of the client user are determined according to the financial transaction network, a classification model is constructed according to the network topology attribute and the non-network topology attribute, colleague and non-colleague relationships and family and non-family relationships that correspond to the client are determined using the classification model, cluster analysis is performed on a calculation result of the network topology attribute and the non-network topology attribute, and a friend relationship corresponding to the client user is determined, thereby resolving problems in the prior art that efficiency of determining a social relationship between the client users is low and the social relationships of the client user are not totally discovered.

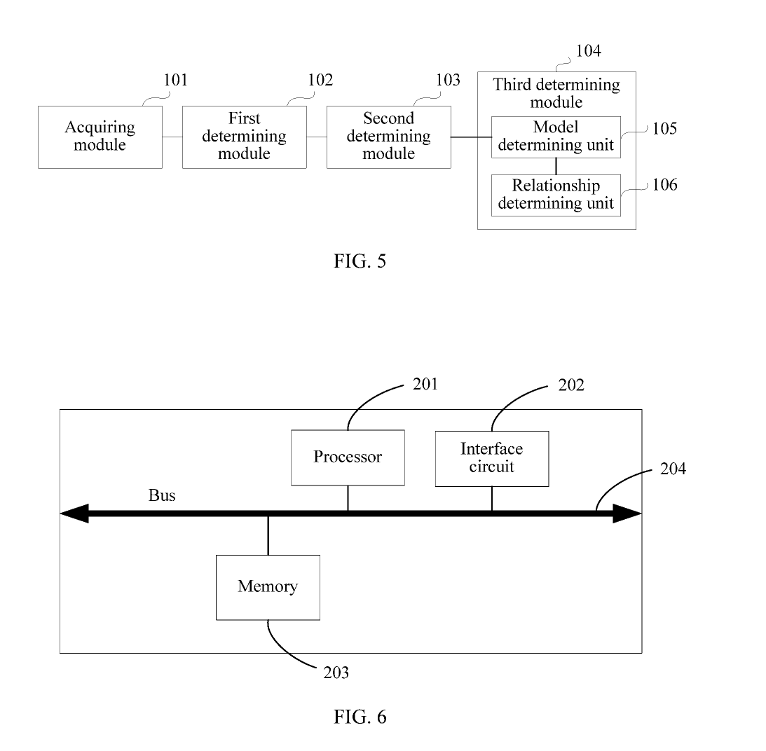

FIG. 5 is a schematic structural diagram of Embodiment 1 of an apparatus for mining a social relationship based on financial data according to the present disclosure. As shown in FIG. 5, the apparatus of this embodiment may include an acquiring module 101 configured to acquire financial transaction data of a client user; a first determining module 102 configured to determine a financial transaction network according to the financial transaction data acquired by the acquiring module 101; a second determining module 103 configured to determine a network topology attribute of the client user and a non-network topology attribute of the client user according to the financial transaction network determined by the first determining module 102; and a third determining module 104 configured to determine, according to a topology attribute of the financial transaction network and the non-network topology attribute that is determined by the second determining module 103, a social relationship corresponding to the client user.

In the foregoing embodiment, the financial transaction data includes first data and second data, where the first data refers to a client user whose social relationship is annotated and the second data refers to a client user whose social relationship is not annotated; and the third determining module includes a model determining unit 105 configured to determine a classification model according to a network topology attribute and a non-network topology attribute of the first data; and a relationship determining unit 106 configured to acquire a social relationship of a client user corresponding to the second data according to the classification model determined by the model determining unit.

The model determining unit 105 is configured to select an attribute according to the network topology attribute of the financial transaction network and the non-network topology attribute; determine a training data set and a test data set according to the first data; construct the classification model according to the training data set and the attribute using a data mining classification algorithm; and test, according to the test data set, whether the classification model passes a model assessment.

The model determining unit 105 is configured to acquire a social relationship of data in the test data set using the classification model, and calculate a match rate between the acquired social relationship of the data in the test data set and an annotated social relationship of the data in the test data set; and if the match rate is higher than a first threshold, determine that the classification model passes the model assessment; or if the match rate is not higher than the first threshold, continue training the classification model.

The third determining module 104 is configured to perform network clustering according to the topology attribute of the financial transaction network and the non-network topology attribute, to acquire the social relationship of the client user.

The financial transaction data of the client user includes an attribute of the client user, a transaction behavior of the client user, a fund flow of the client user, a fund amount of the client user, and a transaction time, a transaction type, and a transaction memo of the client user; and the first determining module 102 is configured to determine nodes of the financial transaction network according to the client user, determine a node attribute of the financial transaction network according to the attribute of the client user, determine edges of the financial transaction network according to the transaction behavior of the client user, where the nodes are connected using the edges, determine directions of the edges according to the fund flow of the client user, determine weights of the edges of the financial transaction network according to the fund amount of the client user, and determine attributes of the edges of the financial transaction network according to the transaction time, the transaction type, and the transaction memo of the client user.

The apparatus in this embodiment may be used to execute the technical solution of the method embodiment shown in FIG. 1. Implementation principles and technical effects are similar, and details are not described herein again.

FIG. 6 is a schematic structural diagram of Embodiment 2 of an apparatus for mining a social relationship based on financial data according to the present disclosure. As shown in FIG. 6, a network device of this embodiment includes a processor 201 and an interface circuit 202. The figure also shows a memory 203 and a bus 204. The processor 201, the interface circuit 202, and the memory 203 are connected and communicate with each other using the bus 204.

The bus 204 may be an industry standard architecture (ISA) bus, a peripheral component interconnect (PCI) bus, an inter-integrated circuit (I²C) bus, or the like. The bus 204 may be classified into an address bus, a data bus, a control bus, and the like. For ease of illustration, the bus in FIG. 6 is represented using only one bold line, but it does not mean that there is only one bus or one type of bus.

The memory 203 is configured to store executable program code, where the program code includes a computer operation instruction. The memory 203 may be a volatile memory, such as a random-access memory (RAM), or may be a non-volatile memory (NVM), such as a read-only memory (ROM), a flash memory, a hard disk drive (HDD), or a solid-state drive (SSD).

The processor 201 may be a central processing unit (CPU).

The processor 201 may invoke the operation instruction and the program code that are stored in the memory 203, to execute the processing method provided in this embodiment of the present disclosure. The method includes acquiring, by the processor 201, financial transaction data of a client user; determining, by the processor 201, a financial transaction network according to the financial transaction data; determining, by the processor 201, a network topology attribute of the client user and a non-network topology attribute of the client user according to the financial transaction network; and determining, by the processor 201 according to a topology attribute of the financial transaction network and the non-network topology attribute, a social relationship corresponding to the client user.

The processor 201 determines nodes of the financial transaction network according to the client user, determines a node attribute of the financial transaction network according to the attribute of the client user, determines edges of the financial transaction network according to the transaction behavior of the client user, where the nodes are connected using the edges, determines directions of the edges according to the fund flow of the client user, determines weights of the edges of the financial transaction network according to the fund amount of the client user, and determines attributes of the edges of the financial transaction network according to the transaction time, the transaction type, and the transaction memo of the client user.

The processor 201 determines a classification model according to a network topology attribute and a non-network topology attribute of the first data; and the processor 201 acquires, according to the classification model, a social relationship of a client user corresponding to the second data.

The processor 201 selects an attribute according to the network topology attribute of the financial transaction network and the non-network topology attribute; the processor 201 determines a training data set and a test data set according to the first data; the processor 201 constructs the classification model according to the training data set and the attribute using a data mining classification algorithm; and the processor 201 tests, according to the test data set, whether the classification model passes a model assessment.

The processor 201 acquires a social relationship of data in the test data set using the classification model, and calculates a match rate between the acquired social relationship of the data in the test data set and an annotated social relationship of the data in the test data set stored in the memory 203; and if the match rate is higher than a first threshold, determines that the classification model passes the model assessment; or if the match rate is not higher than the first threshold, continues training the classification model.

The processor 201 performs network clustering according to the topology attribute of the financial transaction network and the non-network topology attribute, to acquire the social relationship of the client user.

The apparatus in this embodiment may be used to execute the technical solution of the method embodiment shown in FIG. 1. Implementation principles and technical effects are similar, and details are not described herein again.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes any medium that can store program code, such as a ROM, a RAM, a magnetic disk, or an optical disc.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. A method for mining a social relationship based on financial data, comprising:
acquiring financial transaction data of a client user;
determining a financial transaction network according to the financial transaction data;
determining a non-network topology attribute of the client user according to the financial transaction network; and
determining, according to a topology attribute of the financial transaction network and the non-network topology attribute, a social relationship corresponding to the client user.

2. The method according to claim 1, wherein the financial transaction data of the client user comprises an attribute of the client user, a transaction behavior of the client user, a fund flow of the client user, a fund amount of the client user, and a transaction time, a transaction type, and a transaction memo of the client user, and wherein determining the financial transaction network according to the financial transaction data comprises:
determining nodes of the financial transaction network according to the client user;
determining a node attribute of the financial transaction network according to the attribute of the client user;
determining edges of the financial transaction network according to the transaction behavior of the client user, wherein the nodes are connected using the edges;
determining directions of the edges according to the fund flow of the client user;
determining weights of the edges of the financial transaction network according to the fund amount of the client user; and
determining attributes of the edges of the financial transaction network according to the transaction time, the transaction type, and the transaction memo of the client user.

3. The method according to claim 1, wherein the financial transaction data comprises first data and second data, wherein the first data refers to data whose social relationship is annotated and the second data refers to data whose social relationship is not annotated, and wherein determining, according to the topology attribute of the financial transaction network and the non-network topology attribute, the social relationship corresponding to the client user comprises:
determining a classification model according to a network topology attribute and a non-network topology attribute of the first data; and
acquiring, according to the classification model, a social relationship of the client user corresponding to the second data.

4. The method according to claim 3, wherein determining the classification model according to the topology attribute and the non-network topology attribute of the first data comprises:
selecting an attribute according to the network topology attribute of the financial transaction network and the non-network topology attribute;
determining a training data set and a test data set according to the first data;
constructing the classification model according to the training data set and the attribute using a data mining classification algorithm; and
testing, according to the test data set, whether the classification model passes a model assessment.

5. The method according to claim 4, wherein testing, according to the test data set, whether the classification model passes the model assessment comprises:
acquiring a social relationship of data in the test data set using the classification model;
calculating a match rate between the acquired social relationship of the data in the test data set and an annotated social relationship of the data in the test data set;
determining that the classification model passes the model assessment when the match rate is higher than a first threshold; and
continuing training the classification model when the match rate is not higher than the first threshold.

6. The method according to claim 1, wherein determining, according to the topology attribute of the financial transaction network and the non-network topology attribute, the social relationship corresponding to the client user comprises performing network clustering according to the topology attribute of the financial transaction network and the non-network topology attribute in order to acquire the social relationship of the client user.

7. An apparatus for mining a social relationship based on financial data, comprising:
a memory storing executable instructions; and
a processor coupled to the memory and configured to:
acquire financial transaction data of a client user;
determine a financial transaction network according to the financial transaction data acquired;
determine a non-network topology attribute of the client user according to the financial transaction network; and
determine, according to a topology attribute of the financial transaction network and the non-network topology attribute, a social relationship corresponding to the client user.

8. The apparatus according to claim 7, wherein the financial transaction data of the client user comprises an attribute of the client user, a transaction behavior of the client user, a fund flow of the client user, a fund amount of the client user, and a transaction time, a transaction type, and a transaction memo of the client user, and wherein the processor is further configured to:
determine nodes of the financial transaction network according to the client user;
determine a node attribute of the financial transaction network according to the attribute of the client user;
determine edges of the financial transaction network according to the transaction behavior of the client user, wherein the nodes are connected using the edges;
determine directions of the edges according to the fund flow of the client user;
determine weights of the edges of the financial transaction network according to the fund amount of the client user; and
determine attributes of the edges of the financial transaction network according to the transaction time, the transaction type, and the transaction memo of the client user.

9. The apparatus according to claim 7, wherein the financial transaction data comprises first data and second data, wherein the first data refers to data whose social relationship is annotated and the second data refers to data whose social relationship is not annotated, and wherein the processor is further configured to:
determine a classification model according to a network topology attribute and a non-network topology attribute of the first data; and
acquire, according to the classification model, a social relationship of a client user corresponding to the second data.

10. The apparatus according to claim 9, wherein the processor is further configured to:
select an attribute according to the network topology attribute of the financial transaction network and the non-network topology attribute;
determine a training data set and a test data set according to the first data;
construct the classification model according to the training data set and the attribute using a data mining classification algorithm; and
test, according to the test data set, whether the classification model passes a model assessment.

11. The apparatus according to claim 10, wherein the processor is further configured to:
acquire a social relationship of data in the test data set by using the classification model;
calculate a match rate between the acquired social relationship of the data in the test data set and an annotated social relationship of the data in the test data set;
determine that the classification model passes the model assessment when the match rate is higher than a first threshold; and
continue training the classification model when the match rate is not higher than the first threshold.

12. The apparatus according to claim 7, wherein the processor is further configured to perform network clustering according to the topology attribute of the financial transaction network and the non-network topology attribute in order to acquire the social relationship of the client user.
